(19) United States
(12) Patent Application Publication
(10) Pub. No.: US 2013/0130094 A1
(43) Pub. Date: May 23, 2013

(54) ELECTRODE TERMINAL FOR SECONDARY BATTERY AND LITHIUM SECONDARY BATTERY INCLUDING THE SAME

(71) Applicant: LG CHEM. LTD., Seoul (KR)

(72) Inventors: Bo Hyun KIM, Daejeon (KR); Han Ho LEE, Seoul (KR); Jong Hyun CHAE, Daejeon (KR); Dae Il KIM, Daejeon (KR); Joong Min LEE, Gunpo-si (KR)

(73) Assignee: LG CHEM. LTD., Seoul (KR)

(21) Appl. No.: 13/740,342

(22) Filed: Jan. 14, 2013

Related U.S. Application Data
(63) Continuation of application No. PCT/KR2012/005196, filed on Jun. 29, 2012.

(30) Foreign Application Priority Data
Jun. 30, 2011 (KR) 10-2011-0064783

(51) Int. Cl. H01M 2/30

(52) U.S. Cl. CPC H01M 2/30
USPC 429/158; 429/211

(57) ABSTRACT

Provided is a lithium secondary battery, which includes a rechargeable electrode assembly sealed within an exterior member; and an electrode terminal (a positive terminal or a negative terminal) electrically connected to the electrode assembly, and partially protruded out of the exterior member. A portion of the electrode terminal exposed out of the exterior member is plated with a corrosion resistant metal. The electrode terminal is directly plated with a corrosion resistant metal such as cobalt, copper, nickel, and platinum to improve corrosion resistance thereof, thereby improving the performance of the lithium secondary battery.

### CROSS-REFERENCE TO RELATED APPLICATIONS

This application is a continuation of International Application No. PCT/KR2012/005196 filed on Jun. 29, 2012, which claims priority from Korean Patent Application No. 10-2011-0064783 filed with Korean Intellectual Property Office on Jun. 30, 2011, the entire contents of which are incorporated herein by reference.

### BACKGROUND OF THE INVENTION

The present invention disclosed herein relates to an electrode terminal for a secondary battery, and a lithium secondary battery including the electrode terminal.

Interest in energy storage technologies has recently been increasingly higher. Efforts to study and develop electrochemical devices are gradually taking concrete shape as application fields of the energy storage technologies not only expand to energy sources for cellular phones, camcorders and notebook personal computers, but also expand to those for electric cars. The electrochemical devices are the most noteworthy field in this respect, and development of rechargeable secondary batteries among the electrochemical devices is becoming the focus of attention. Research and development have recently been worked on design of new electrodes and batteries in order to improve capacity density and specific energy in the development of such batteries.

Lithium secondary batteries developed in the early 1990s among currently applicable secondary batteries are in the spotlight due to their merits of high operating voltages and far large energy densities compared to typical batteries such as Ni—MH batteries, Ni—Cd batteries, and sulfuric acid-lead batteries using aqueous electrolyte solutions.

Lithium metals, lithium alloys, stannum oxides, and carbon materials such as graphite and coke are suggested as metals used to form a negative electrode of a lithium secondary battery. Of these, carbon materials are already been commercialized to form a negative electrode of a lithium secondary battery. Since graphite has a significantly low discharge potential near the electric potential of a lithium metal, and can be used to form a lithium secondary battery having high energy density, graphite is widely used to form a negative electrode.

A positive terminal of such lithium secondary batteries is formed of aluminum. This is because when a lithium secondary battery is charged and discharged, aluminum is stable at the electric potential of a positive electrode. Although titanium and stainless steel are also stable in electric potential, aluminum is most widely used in consideration of workability, conductivity, and material costs.

However, since aluminum tends to form an oxide thin layer, when aluminum is used to form a positive terminal, a portion of the positive terminal, exposed out of an exterior member of a lithium secondary battery to connect to an electrode lead, may be corroded. Particularly, when a lithium secondary battery is used in a salty area, the corrosion of a positive terminal is accelerated to thereby increase contact resistance of a connecting portion of the positive terminal, which causes a contact failure or decreases a discharge voltage.

### SUMMARY OF THE INVENTION

The present invention provides an electrode terminal for a secondary battery, and a lithium secondary battery including the electrode terminal, in which a portion of the electrode terminal exposed out of an exterior member of the secondary battery is entirely plated with a corrosion resistant metal to prevent the electrode terminal from being corroded by a salty material, thereby improving anti-fatigue performance and adhesion force of a welding portion, and functioning as a high strength and high power terminal.

Embodiments of the present invention provide electrode terminals for a secondary battery, including a metal having higher corrosion resistance than that of a metal constituting the electrode terminal, wherein the electrode terminal is plated with the metal having the higher corrosion resistance.

In other embodiments of the present invention, lithium secondary batteries include: a rechargeable electrode assembly sealed within an exterior member; and an electrode terminal (a positive terminal or a negative terminal) electrically connected to the electrode assembly, and partially protruded out of the exterior member, wherein the electrode terminal includes a metal having higher corrosion resistance than that of a metal constituting the electrode terminal, and the electrode terminal is plated with the metal having the higher corrosion resistance.

In some embodiments, the electrode terminal may be formed of aluminum. The electrode terminal may be plated with at least one selected from the group consisting of cobalt, copper, nickel, platinum, manganese, zinc, iron, stannum, silver, and gold, which have higher corrosion resistance than that of aluminum.

In other embodiments, the electrode terminal may be formed of copper. The electrode terminal may be plated with at least one selected from the group consisting of nickel, platinum, silver, and gold, which have higher corrosion resistance than that of copper.

In still other embodiments, the plating of the electrode terminal may be electrolytic plating or non-electrolytic plating.

In even other embodiments, at least one portion of the electrode terminal may be plated with the metal.

In yet other embodiments, a portion of the electrode terminal exposed out of the exterior member of the lithium secondary battery may be plated with the metal.

In further embodiments, the lithium secondary battery may be a pouch type secondary battery.

In still other embodiments of the present invention, battery modules or battery packs include: two or more lithium secondary batteries electrically connected to each other therein, wherein at least one portion of an electrode terminal (a positive terminal or a negative terminal) electrically connecting the lithium secondary battery to an outside thereof is plated with a metal having higher corrosion resistance than that of a metal constituting the electrode terminal.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a schematic view illustrating an electrode terminal for a lithium secondary battery according to an embodiment of the present invention;

FIG. 2 is an exploded perspective view illustrating a pouch type secondary battery according to another embodiment of the present invention;

FIG. 3 is a perspective view illustrating the pouch type secondary battery of FIG. 2;

FIG. 4 is an exploded perspective view illustrating a pouch type secondary battery according to another embodiment of the present invention; and

FIG. 5 is a perspective view illustrating the pouch type secondary battery of FIG. 4.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Hereinafter, an electrode terminal for a secondary battery, and a lithium secondary battery including the electrode terminal according to embodiments of the present invention will be described in detail with reference to the accompanying drawings.

The electrode terminal is plated with a metal that has higher corrosion resistance than that of a metal constituting the electrode terminal. The lithium secondary battery includes: a rechargeable electrode assembly sealed within an exterior member; and the above electrode terminal (as a positive or a negative terminal). The electrode terminal is electrically connected to the electrode assembly, and partially protrudes out of the exterior member.

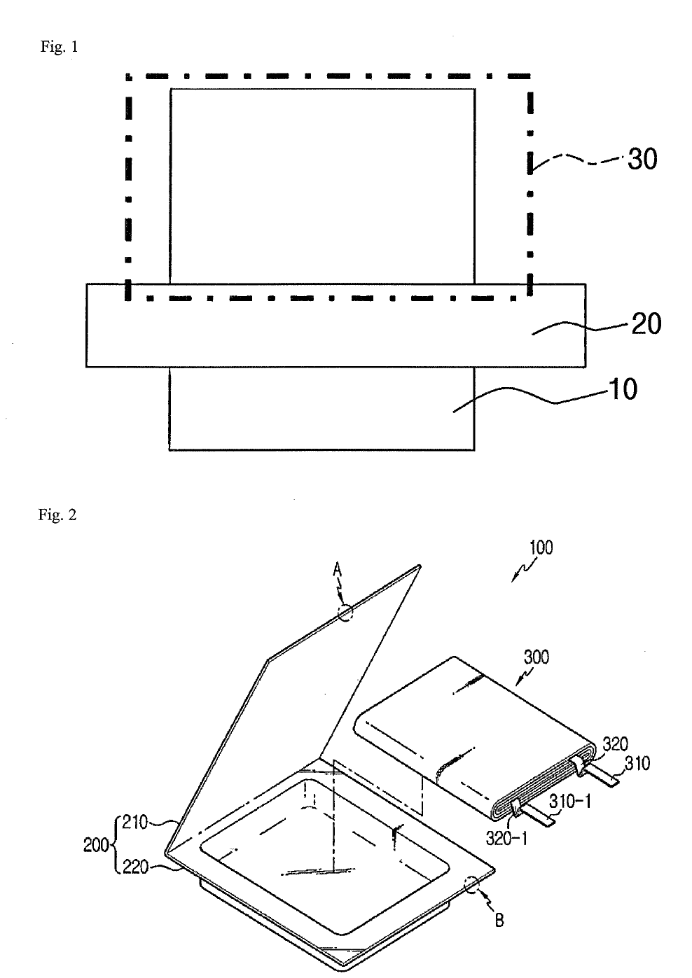

Referring to FIG. 1, a lithium secondary battery according to an embodiment of the present invention includes a rechargeable electrode assembly and an electrode terminal (a positive or negative terminal) 10. The electrode assembly is sealed within an exterior member including a laminate sheet having a resin layer and a metal layer. The electrode terminal 10 is electrically connected to the electrode assembly, and partially protrudes out of the exterior member to connect to an external terminal. An insulating film 20 may be attached to the electrode terminal 10.

The electrode terminal 10 leading out from an electrode of the lithium secondary battery is electrically connected to the electrode assembly, and an exposed portion (in a region 30 depicted with a dot-dash line) of the electrode terminal 10 exposed out of the exterior member is entirely plated with a metal that has higher corrosion resistance than that of the electrode terminal 10.

Since the corrosion resistance of a metal is varied according to potential differences and environmental conditions such as temperature, concentration, and atmosphere (oxidation atmosphere or reduction atmosphere), ‘a metal having higher corrosion resistance than that of a metal constituting an electrode terminal’ described herein means a metal having a smaller corroded amount per unit time under the same potential difference and the same environmental conditions than that of a metal constituting an electrode terminal. For example, when being immersed in salt water with the same temperature and concentration for a certain period of time, a metal having a smaller corroded amount than that of a metal constituting an electrode terminal can be used as a metal for the plating.

Particularly, a positive terminal is formed of aluminum in consideration of workability, conductivity, and costs, and aluminum may be corroded by reacting with a salty material. Thus, a positive terminal exposed out of an exterior member should be plated with a corrosion resistant metal.

The corrosion resistant metal may be any metal that has higher corrosion resistance than that of aluminum and that is appropriate for plating. For example, when an electrode terminal is formed of aluminum, at least one selected from the group consisting of cobalt, nickel, platinum, manganese, zinc, iron, stanuum, silver, and gold may be used to plate the electrode terminal.

When a negative terminal is formed of copper, at least one selected from the group consisting of nickel, platinum, silver, and gold, which have higher corrosion resistance than that of copper, may be used to plate the negative terminal, but metals used to plate a negative terminal are not limited thereto.

A metal used to plate the electrode terminal may be lower in degree of ionization than a metal used to form the electrode terminal.

An electrode terminal plated with a corrosion resistant metal according to the present invention has higher corrosion resistance by about 5% to about 20% than that of a typical electrode terminal.

Any plating method may be used to entirely plate a portion of an electrode terminal protruding out of an exterior member. For example, electrolytic plating or non-electrolytic plating may be used.

When the electrolytic plating (electroplating) is used to plate an aluminum positive terminal or a negative terminal, a plating target portion is not specifically limited, and thus, at least one portion of the positive or negative terminal may be plated with a metal. For example, only a portion protruded (exposed) out of an exterior member of a battery may be plated.

In this case, a plating process is simplified, and the service life of a plating solution is increased, and the management thereof is facilitated. In addition, a plating speed is increased, and adhesion force to a base material is increased. Furthermore, resistance applied to the outside of a battery can be lower when a portion of an electrode terminal is plated than when an electrode is entirely plated, and material costs can be further decreased.

When a positive terminal or a negative terminal is partially plated with using the non-electrolytic plating, a partially plated portion has a uniform thickness unlike using the electrolytic plating (electroplating). At this point, when the thickness of the partially plated portion is about 125 μm or smaller, it is unnecessary to grind the surface of the partially plated portion.

As described above, the lithium secondary battery includes a positive terminal and/or a negative terminal, which is plated with a metal having higher corrosion resistance than that of a material constituting the positive terminal and/or the negative terminal. Particularly, only a protruded portion of the positive terminal and/or the negative terminal out of the lithium secondary battery may be plated, as described above.

When an electrode terminal is taped with an insulating film, order of the above-described plating and the taping of the electrode terminal is not specifically limited. For example, plating of an electrode terminal may be followed by taping thereof.

The form of the electrode assembly included in the lithium secondary battery is not specifically limited, and thus, the electrode assembly may be one of various electrode assemblies such as a stack type one, a jelly-roll type one, a stack & folding type one that is wound in one direction, and a Z-stack & folding type one that is wound in zigzag shape.

Furthermore, the electrode assembly may be a unidirectional electrode assembly including positive and negative terminals protruding in the same direction, or be a bidirectional electrode assembly including positive and negative terminals protruding in different directions.

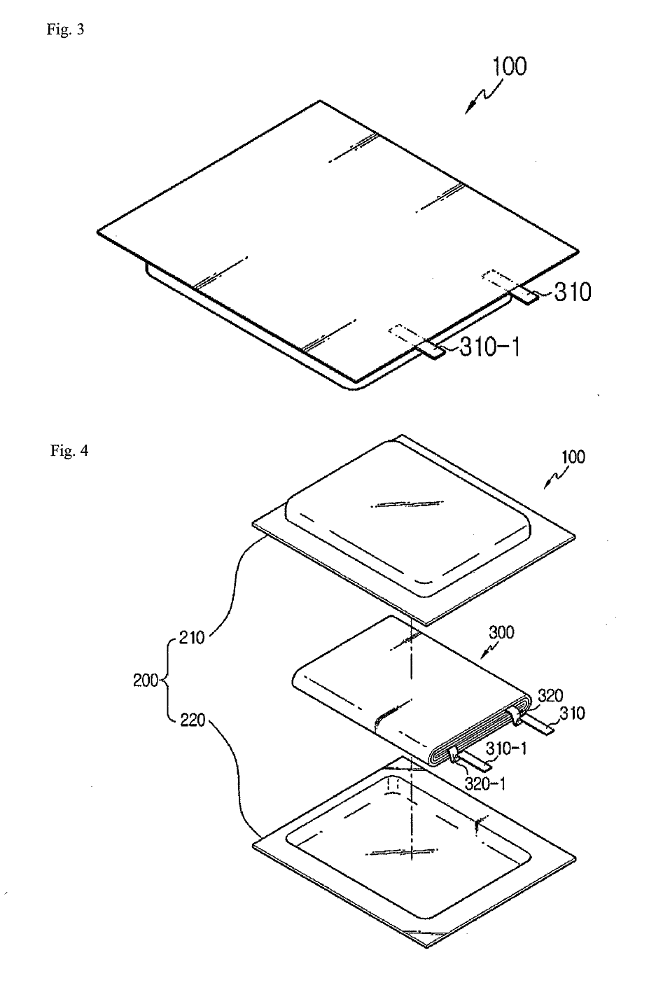

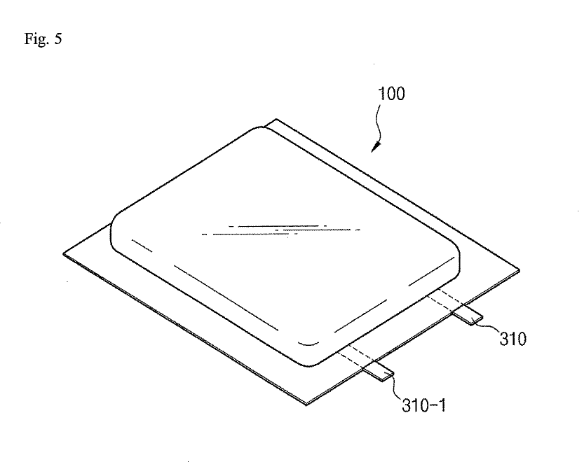

Referring to FIGS. 2 and 3, a lithium secondary battery 100 according to another embodiment of the present invention may include a pouch type exterior member 200 that includes an upper exterior member 210 and a lower exterior member 220 which are connected to each other. An accommodating part may be disposed in only the lower exterior member 220 to accommodate an electrode assembly 300. Alternatively, referring to FIGS. 4 and 5, a lithium secondary battery 100 according to another embodiment of the present invention may include a pouch type exterior member 200 that includes an upper exterior member 210 and a lower exterior member 220 which are separated from each other. Accommodating parts may be disposed in both the upper exterior member 210 and the lower exterior member 220 to accommodate an electrode assembly 300.

According to embodiments of the present invention, shapes and manufacturing methods of an electrode assembly including an electrode terminal, and shapes and manufacturing methods of a pouch type lithium secondary battery including the electrode assembly are not specifically limited. Thus, the electrode assembly and the pouch type lithium secondary battery may be manufactured using well known methods.

Furthermore, the electrode terminal may be used not only in a lithium secondary battery, but also as an electrode lead of a battery module or battery pack including two or more lithium secondary batteries electrically connected to each other.

According to the embodiments, an electrode terminal is directly plated with a corrosion resistant metal such as cobalt, copper, nickel, and platinum to improve corrosion resistance thereof, thereby improving the performance of a lithium secondary battery. Along with the plating of the electrode terminal, a battery pack in which the lithium secondary battery is provided at least in two can be improved in design.

It will be understood that although the terms “upper (or equivalents thereof)” and “lower (or equivalents thereof)” are used herein to relatively discriminate elements from one another and to efficiently describe them, these terms should not be construed as absolutely discriminating elements from one another in terms of physical positions, relative positions, and importance.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electrode terminal for a secondary battery, comprising a metal having higher corrosion resistance than that of a metal constituting the electrode terminal,
wherein the electrode terminal is plated with the metal having the higher corrosion resistance.

2. A lithium secondary battery comprising:
a rechargeable electrode assembly sealed within an exterior member; and
an electrode terminal (a positive terminal or a negative terminal) electrically connected to the electrode assembly, and partially protruded out of the exterior member,
wherein the electrode terminal comprises a metal having higher corrosion resistance than that of a metal constituting the electrode terminal, and
the electrode terminal is plated with the metal having the higher corrosion resistance.

3. The lithium secondary battery of claim 2, wherein the electrode terminal is formed of aluminum.

4. The lithium secondary battery of claim 3, wherein the electrode terminal is plated with at least one selected from the group consisting of cobalt, copper, nickel, platinum, manganese, zinc, iron, stannum, silver, and gold, which have higher corrosion resistance than that of aluminum.

5. The lithium secondary battery of claim 2, wherein the electrode terminal is formed of copper.

6. The lithium secondary battery of claim 5, wherein the electrode terminal is plated with at least one selected from the group consisting of nickel, platinum, silver, and gold, which have higher corrosion resistance than that of copper.

7. The lithium secondary battery of claim 2, wherein the plating of the electrode terminal is electrolytic plating or non-electrolytic plating.

8. The lithium secondary battery of claim 2, wherein at least one portion of the electrode terminal is plated with the metal.

9. The lithium secondary battery of claim 2, wherein a portion of the electrode terminal exposed out of the exterior member of the lithium secondary battery is plated with the metal.

10. The lithium secondary battery of claim 2, wherein the lithium secondary battery is a pouch type secondary battery.

11. A battery module or a battery pack, comprising:
two or more lithium secondary batteries electrically connected to each other therein,
wherein at least one portion of an electrode terminal (a positive terminal or a negative terminal) electrically connecting the lithium secondary battery to an outside thereof is plated with a metal having higher corrosion resistance than that of a metal constituting the electrode terminal.
